(19) United States
(12) Patent Application Publication
(10) Pub. No.: US 2022/0355318 A1
(43) Pub. Date: Nov. 10, 2022

(54) FOAM DISPENSER

(71) Applicant: Kao Corporation, Tokyo (JP)

(72) Inventor: Shinji WATANABE, Darmstadt (DE)

(73) Assignee: Kao Corporation, Tokyo (JP)

(21) Appl. No.: 17/633,529

(22) PCT Filed: Aug. 8, 2019
(86) PCT No.: PCT/IB2019/056755

§ 371 Date: Feb. 7, 2022

(51) Int. Cl. B05B 7/00; B05B 11/00; B01F 23/235; B01F 25/25; B01F 25/23; B01F 25/452; B01F 25/72; B01F 33/501

(52) U.S. Cl. CPC B05B 7/0031; B05B 11/3087; B01F 23/235; B01F 25/25; B01F 25/23; B01F 25/452; B01F 25/72; B01F 33/50111; A47K 5/14

(57) ABSTRACT

The invention refers to a foam dispenser. The foam dispenser is suitable for dispensing foam produced by mixing a foaming liquid and gas, in particular air. Further, the invention refers to foam dispenser assembly, a vessel for storing a foamable aqueous composition and a method for forming foam using the foam dispenser.

### TECHNICAL FIELD

The invention refers to a foam dispenser. The foam dispenser is suitable for dispensing foam produced by mixing a foaming liquid and gas, in particular air. Further, the invention refers to foam dispenser assembly, a vessel for storing a foamable aqueous composition and a method for forming foam using the foam dispenser.

### BACKGROUND ART

EP 2 578 512 A1 discloses a foam discharge container capable of discharging foam with uniform and stable quality. The foam discharge container is provided with a plurality of liquid introduction paths for introducing a foaming liquid into an air-liquid mixing chamber and a plurality of air introduction paths for introducing air thereinto, thereby making it possible to remarkably improve the air-liquid mixing efficiency and stabilize the supply amounts of the air and the foaming liquid without a large amount of liquid flowing into the air-liquid mixing chamber by one push.

### SUMMARY OF THE INVENTION

The present invention provides a foam dispenser, comprising:

a base portion and a front portion,

a mixing portion being formed between the base portion and the front portion, the mixing portion having a circumferential wall,

at least one liquid supply channel and at least one gas supply channel, the liquid supply channel and the gas supply channel being in fluid connection with the mixing portion via at least one liquid outlet opening and at least one gas outlet opening, respectively, wherein

the foam dispenser comprises at least one dispersing section, wherein the dispersing section is configured to disperse a liquid stream when or after entering the mixing portion to mix with the gas in a dispersed state.

According to a second aspect, the present invention provides a foam dispenser assembly, comprising the foam dispenser as defined above and a liquid container, wherein the foam dispenser assembly is preferably selected from a propellant foamer assembly, a pump foamer assembly and a squeeze foamer assembly, and more preferably is a pump foamer assembly.

According to a third aspect, the present invention provides a vessel for storing a foamable aqueous composition having attached to it a cap comprising the foam dispenser as defined above.

According to a fourth aspect, the present invention provides a method for forming foam using the foam dispenser according to any one of claims 1 to 15 or the foam dispenser assembly according to claim 16, comprising the steps of: introducing gas, in particular pressurized air, in a mixing portion, introducing liquid in the mixing portion, wherein the liquid is introduced so that the liquid stream is dispersed when or after entering the mixing portion to mix with the gas in a dispersed state.

### BRIEF DESCRIPTION OF THE DRAWINGS

The drawings illustrate embodiments of the invention, and, together with the description, explain various embodiments of the disclosed subject matter. The drawings have not necessarily been drawn to scale, and the dimensions in the accompanying drawings are for illustration purposes.

FIG. 1 is a perspective view of a cross-section showing a first embodiment of a foam dispenser according to the invention.

FIG. 2 is a cross-sectional side view of the foam dispenser according to the first embodiment.

FIG. 3a shows a die insert being part of the foam dispenser of the first embodiment.

FIG. 3b shows a cross-sectional view of the die insert of FIG. 3a.

FIG. 4 shows a modification of an opening portion of the die insert of FIGS. 3a, 3b.

FIGS. 5a-5c are variations of the die insert as viewed from a bottom side thereof.

FIG. 6 is a perspective view of a cross-section of a foam dispenser according to a second embodiment of the invention.

FIG. 7 is a cross-sectional view of a third embodiment of the foam dispenser of the invention.

FIG. 8 shows a cross-sectional view of a foam dispenser assembly comprising a foam dispenser according to the invention.

FIG. 9 is a cross-sectional view of a foam dispenser assembly comprising a foam dispenser according to the invention.

### DETAILED DESCRIPTION OF THE INVENTION

The invention aims to a device for preparing foam with improved foam stability, soft feel and rich appearance of the foam.

Although approaches are known to provide foam with uniform and stable quality, a well-balanced foam quality remains an object to be further improved. As one of the aspects, such foam should provide both a positive haptic and visual experience to the consumer.

With the foam dispenser of the invention, foam with a small and uniform bubble size, high foam stability and a rich appearance can be provided. In addition, the foam produced with said foam dispenser has a positive haptic feature, in particular a soft feel, which is preferred by consumers.

Claim 1 provides such a foam dispenser.

Hereafter, embodiments and variations of the present invention are described in further detail. Variations and modifications of specific aspects of the embodiments can be combined so as to provide further embodiments. Although the embodiments, modifications and variations are not to be understood as limiting, but rather as examples to enhance the understanding of the invention, single features of the embodiments, modifications and variations or a combination thereof can be used to specify the invention as defined in the appended claims.

Foam Dispenser

The invention provides a foam dispenser, comprising: a base portion and a front portion, a mixing portion being formed between the base portion and the front portion, the mixing portion having a circumferential wall, at least one liquid supply channel and at least one gas supply channel. The liquid supply channel and the gas supply channel are in fluid connection with the mixing portion via at least one liquid outlet opening and at least one gas outlet opening, respectively. The foam dispenser comprises at least one dispersing section. The dispersing section is configured to disperse a liquid stream when or after entering the mixing portion to mix with the gas in a dispersed state.

The foam dispenser 10 comprises a base portion 11 and a front portion 12 connected to each other. An outer circumferential wall lla of a first end portion of the base portion 11 engages an inner circumferential wall of the front portion 12. On a radially inner side of the outer circumferential wall lla of the base portion 11, a circumferential gap is provided which forms a liquid supply channel 16.

The foam dispenser may be preferably attached hand-held container or bottle, and the liquid is preferably charged in container. The foam dispenser may be preferable non-aerosol device.

### First Embodiment—Die Insert

The foam dispenser can comprise a die insert. The die insert can be attached to the base portion and comprises the liquid outlet opening. Specific configurations of the liquid outlet opening can be provided by attaching a corresponding die insert to the base portion. Thus, variability of fabrication of the foam dispenser is increased, while assuring a cost-effective production process.

A protruding portion 13c of a die insert 13 is inserted into the gap of the base portion 11, thereby attaching the die insert 13 to the base portion 11.

The base portion 11, the front portion 12 and the die insert 13 are fabricated by injection-molding. Since the die insert is formed separately from the base portion 11, the configuration of the die insert 13 can be varied, in particular the configuration and dimension of a liquid outlet opening 13a of the die insert 13 which will be described in further detail below.

A mixing portion (mixing chamber) 14 is formed between the base portion 11 and the front portion 12. In particular, the mixing portion 14 is provided between an upper section of the die insert 13 attached to the base portion 11, an inner circumferential wall 14b of the front portion 12 and an inner wall 14a of the front portion 12, the inner wall 14a being opposite to the upper section of the die insert 13. The die insert 13 is attached to the base portion 11 so that the upper section of the die insert 13 provides a bottom portion of the mixing portion 14.

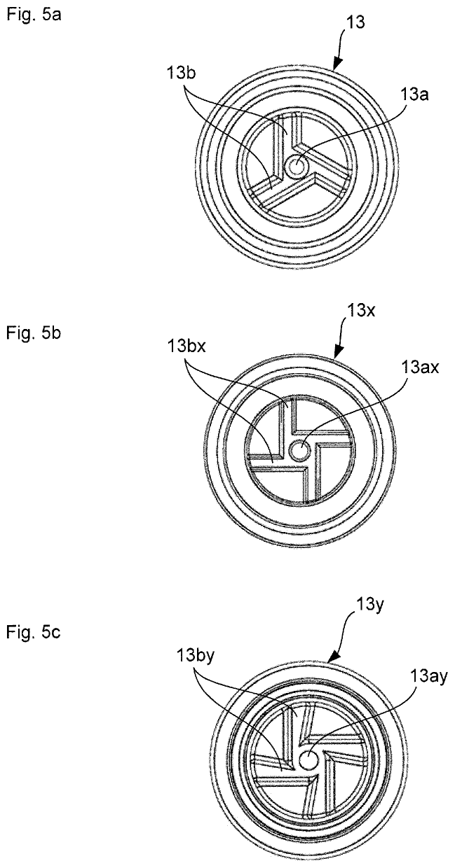

FIGS. 5a-5c show plane views of different variations of a section of the die insert facing the base portion 11, i.e. the lower portion of the die insert. Aspects of the variations can be combined to provide further modifications. For example, the number of channels or the shape of the channels can be changed.

According to a first variation shown in FIG. 5a, the die insert 13 is provided with three channels 13b guiding liquid to the liquid outlet opening 13a. The channels 13b are arranged so that the channels 13b are equally spaced in a circumferential direction, with an angle of approximately 120° between the channels 13b.

FIG. 5b illustrates a second variation of a die insert 13x which can be provided in the foam dispenser according to the first embodiment. The die insert 13x comprises four channels l3bx, which guide liquid to the liquid opening l3ax provided in the center of the die insert 13x. The channels l3b x are equally spaced in a circumferential direction, with an angle of approximately 90° between the channels l3bx.

A third variation of the die insert 13y is shown in FIG. 5c. Similar to FIG. 5b, the die insert 13y comprises four channels l3by guiding liquid to the liquid outlet opening l3ay. However, the channels l3by of the die insert 13y have a shape which narrows towards the liquid outlet opening l3ay.

### First Embodiment—Inner Wall

According to a further aspect, the dispersing section comprises an inner wall, which is arranged opposite to the liquid outlet opening. Since the inner wall is arranged opposite to the liquid outlet opening, a liquid stream from the liquid outlet opening can be dispersed so as to form finer droplets when impinging on the inner wall. By this configuration, the foam forming process is further enhanced.

The inner wall can be arranged so that at least parts of the liquid dispensed from the liquid outlet opening reach the inner wall prior to deflection at the circumferential wall of the mixing portion. Thus, fine droplets can be provided which leads to stable foam, soft feel and rich appearance.

The inner wall 14a of the mixing portion 14 is provided with a plurality of orifices 12b that are arranged on a radially outer side of the inner wall 14a, the plurality of orifices 12b extending in an axial direction of the front portion 12 and providing through holes in the inner wall 14a.

According to a preferred aspect, the inner wall comprises one or more orifices for discharging foam and the location of the one or more orifices is/are radially outward of the liquid outlet opening. Thus, a liquid stream from the liquid outlet opening can be dispersed on the inner wall so as to form fine droplets, hereafter mixes with gas introduced into the mixing portion and then leaves the mixing portion in a mixed state.

It is preferred that none of the one or more orifices is in axial direction to the liquid outlet opening so that liquid stream from the liquid outlet opening can be dispersed on the inner wall. Consequently, fine droplets can be formed in the mixing portion.

The inner wall 14a is arranged opposite to the liquid outlet opening 13a so that liquid entering the mixing portion 14 through the liquid outlet opening 13a is directed to the inner wall 14a. By this arrangement, the inner wall 14a serves as a dispersing section which is configured to disperse a liquid stream which has passed through the opening 13a and through the mixing portion 14. Since the liquid stream is dispersed by the inner wall 14a, fine droplets are provided in the mixing portion 14. The fine droplets mix with the gas supplied by the plurality of gas outlet openings, thereby providing stable foam with soft feel and rich appearance.

### First Embodiment—Liquid and Gas Supply Channels

The foam dispenser 10 further comprises the liquid supply channel 16 formed by the circumferential gap in the base portion 11 and a gas supply channel 15. The liquid supply channel 16 is arranged closer to the axis of the base portion 11 as compared to the gas supply channel 15.

Both the liquid supply channel 16 and the gas supply channel 15 are in fluid connection with the mixing portion 14. In particular, the liquid supply channel 16 is in fluid connection with the liquid outlet opening 13a provided in the die insert 13. The gas supply channel 15 is in fluid connection with a plurality of gas outlet openings 15a which are arranged at an outer side of the die insert 13.

The ratio of the largest cross-sectional distance of one or more liquid flow channels to the diameter of the opening of the liquid outlet is in the range of 1:0.4 to 1:4. Experiments conducted by the inventors show that this range is favorable to modify the liquid stream entering the mixing chamber, which again leads to an improved foam quality.

According to another aspect, the liquid flow channels are connected with the liquid outlet opening in a non-mirror-symmetric manner so as to confer a rotational component to the discharged liquid. A liquid stream comprising a rotational component provided by this configuration affects the dispersing capability of the liquid stream in the mixing portion so that the liquid can form fine droplet in the mixing portion.

As a further aspect, the liquid outlet opening and the gas outlet opening can be located apart and on different walls of the mixing portion. According to another configuration, the liquid outlet opening of the liquid supply channel and the gas outlet opening of the gas supply channel can be located apart and on different walls of the mixing portion. According to these embodiments, liquid and gas can enter the mixing portion separately. The liquid can be dispersed when or after entering the mixing portion, and hereafter, gas can mix with the finely dispersed liquid in the mixing portion.

The gas outlet opening of another preferred aspect is located at a radially outer side of the liquid outlet opening. Gas entering the mixing portion is guided closer to a circumferential wall of the mixing portion, whereas the liquid stream enters the mixing portion at a radially inner side.

According to another aspect, the ratio of the largest cross-sectional distance of one or more gas outlet openings to the diameter of the liquid outlet opening is in the range of 1:0.25 to 1:4. Thereby, foam with a uniform bubble size, high foam stability and a rich appearance can be provided.

According to a preferred aspect, the gas entering the mixing portion is a pressurized gas. As an example, the pressurized gas is pressurized air. The pressurized gas or air is introduced into the mixing portion so that liquid from the liquid outlet opening can mix with the pressurized gas or air, thereby forming foam. Preferably, the pressurized gas is pumped from a gas chamber, more preferably the pressurized liquid is pumped from a liquid chamber.

### First Embodiment—Liquid Outlet Opening

The liquid outlet opening can be configured as a jet die to discharge a jet of liquid in axial direction against the inner wall. In this configuration, the liquid stream impinges the inner wall with a relatively high impulse so that the liquid is finely dispersed in the mixing portion.

According to another aspect, the dispersing section comprises the liquid outlet opening which is configured as a dispersing die to disperse the liquid stream leaving the opening. Since the liquid is already dispersed in small droplets state when leaving the opening, mixing with gas introduced is improved, which leads to a stable configuration of the foam produced in the mixing portion.

The liquid outlet opening can be connected to the liquid supply channel via one or more liquid flow channels, the liquid flow channels having narrower cross-section than the liquid supply channel. Thus, the liquid stream is configured in a preferable manner before entering the mixing portion via the liquid outlet opening.

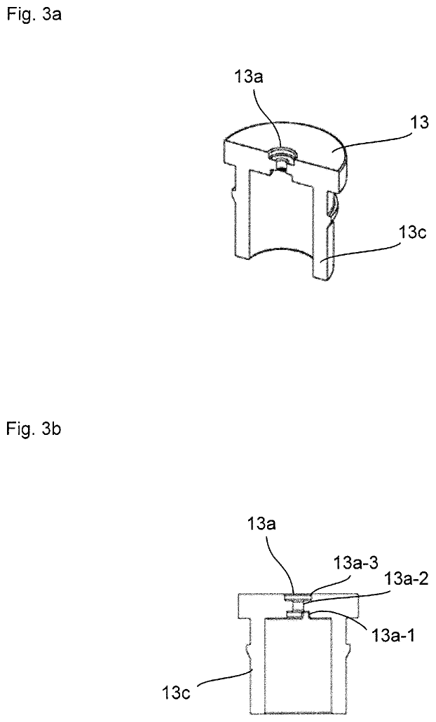

FIG. 3a shows a perspective view of a cross-section of the die insert 13 which is part of the first embodiment. The die insert 13 is provided with the liquid outlet opening 13a at a center thereof.

The liquid outlet opening 13a comprises an inlet section 13a-1, a middle section 13a-2 and an outlet section 13a-3. The outlet section 13a-3 faces the mixing portion 14. The middle section has a smaller diameter as compared to the inlet section 13a-1 and the outlet section 13a-3. Since the diameter of the outlet section 13a-3 is larger than the diameter of the middle section 13a-2, the liquid passing through the opening 13a is dispersed. Considering the liquid stream in cross-section, the liquid stream enters the mixing portion in the shape of a cone so that the liquid stream is already dispersed while entering the mixing portion 14. The liquid stream dispersed when entering the mixing portion 14 contributes to the formation of fine droplets in the mixing portion 14, thereby enhancing the foam formation process.

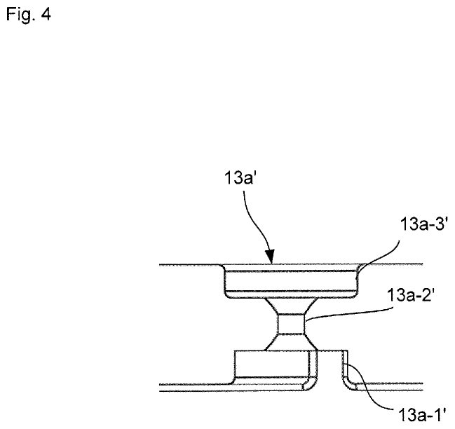

FIG. 4 refers to a modification of a liquid outlet opening 13a′ provided in the die insert. The liquid outlet opening 13a′ comprises an inlet section 13a-1′, a middle section 13a-2′ and an outlet section 13a-3′. The outlet section 13a-3 faces the mixing portion of the liquid dispenser.

According to the modification of FIG. 4, the middle section 13a-2′ comprises a first cone section narrowing the diameter in the flow direction of the liquid stream, a center section with a substantially constant diameter and a second cone section widening the diameter in the flow direction of the liquid stream. The diameter of the second cone section adjacent to the outlet section 13a-3′ is smaller than the diameter of the outlet section 13a-3′.

The liquid outlet opening can have a larger cross-sectional diameter at the outermost portion facing the mixing portion than at a portion adjacent to the outermost portion. With this configuration, the liquid stream can be dispersed when entering the mixing portion.

In the flow direction of liquid passing through the opening of the liquid supply channel, the cross-sectional diameter of the opening of the liquid supply channel can decrease and then increase, preferably step-wise or continuously. Thereby, the liquid stream can be dispersed when entering the mixing portion.

According to a yet further aspect, the base portion and the front portion can be attached to each other, thereby providing variability in the fabrication process of the foam dispenser.

The liquid outlet opening can be configured as a venturi nozzle so that the foam forming process is further enhanced.

### First Embodiment—Foam Dispenser Assembly

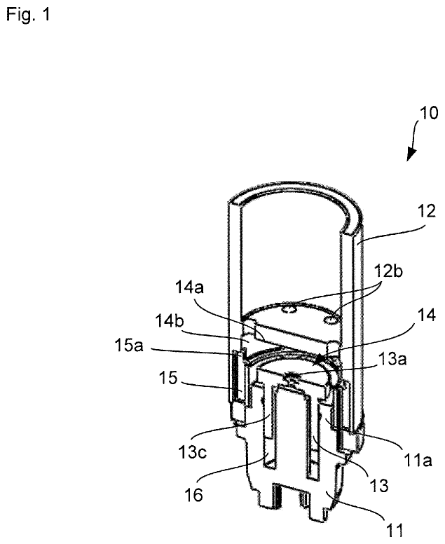

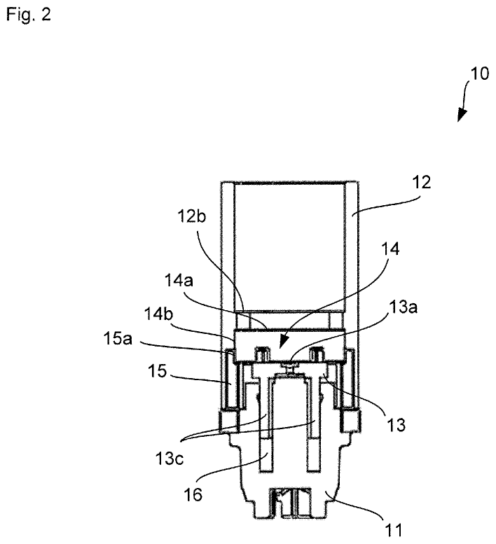

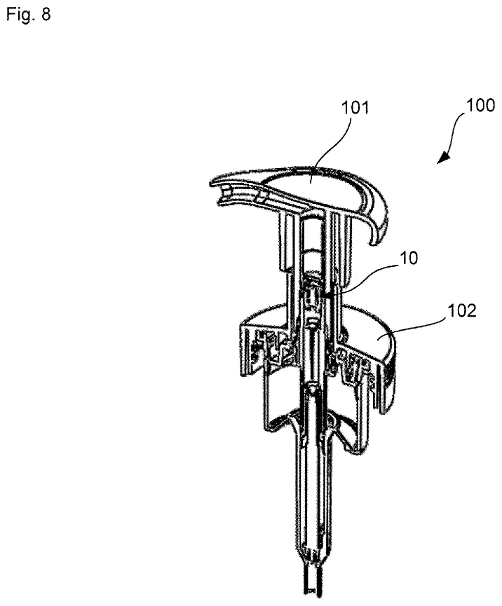

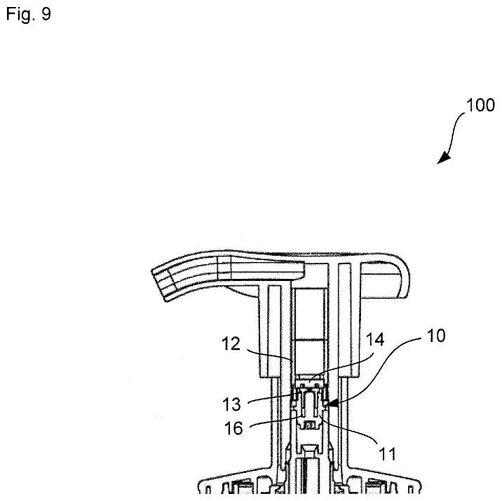

A first embodiment of a foam dispenser 10 is shown in FIG. 1. Such a foam dispenser 10 can be incorporated in a foam dispenser assembly, as for example a foam dispenser assembly 100 of FIGS. 8-9. The foam dispenser assembly 100 can be attached to a vessel or container used for storing a foamable aqueous composition therein. The foam dispenser assembly 100 comprises a handling section 101 for a pump operation and a mounting section 102 for mounting the foam dispenser assembly 100 to a vessel. The vessel (not shown) comprises an aqueous composition.

### Second Embodiment—Foam Dispenser

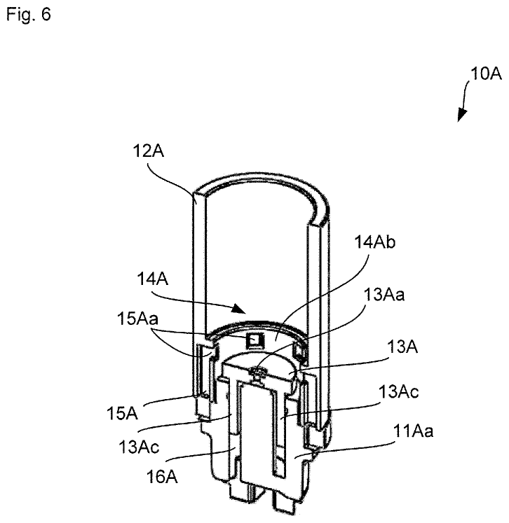

FIG. 6 shows a second embodiment of the foam dispenser of the invention. The foam dispenser 10A differs from the foam dispenser of the first embodiment in that no inner wall is provided.

The foam dispenser 10A of the second embodiment can be incorporated in a foam dispenser assembly, as for example a foam dispenser assembly 100 of FIGS. 8-9. The foam dispenser assembly 100 can be attached to a vessel or container used for storing a foamable aqueous composition therein. Similar components are marked with similar reference signs. Reference is also made to the explanations of the first embodiment.

The foam dispenser 10A comprises a base portion 11A and a front portion 12A connected to each other. An outer circumferential wall 11Aa of a first end portion of the base portion 11A engages an inner circumferential wall of the front portion 12A. On a radially inner side of the outer circumferential wall 11Aa of the base portion 11A, a circumferential gap is provided which forms a liquid supply channel 16A. A protruding portion 13Ac of a die insert 13A is inserted into the gap of the base portion 11A, thereby attaching the die insert 13 to the base portion 11A.

### Second Embodiment—Die Insert

Similar to the first embodiment, the base portion 11, the front portion 12A and the die insert 13A are fabricated by injection-molding.

A mixing portion (mixing chamber) 14A is formed above an upper section of the die insert 13A attached to the base portion 11A and a circumferential wall 14Ab of the front portion 12A. The die insert 13A is attached to the base portion 11A so that the upper section of the die insert 13A provides a bottom portion of the mixing portion 14A.

### Second Embodiment—Liquid and Gas Supply Channels

The foam dispenser 10A comprises the liquid supply channel 16A formed by the circumferential gap in the base portion 11A and a gas supply channel 15A. The liquid supply channel 16A is arranged closer to the axis of the base portion 11A as compared to the gas supply channel 15A.

Both the liquid supply channel 16A and the gas supply channel 15A are in fluid connection with the mixing portion 14. In particular, the liquid supply channel 16A is in fluid connection with the liquid outlet opening 13Aa provided in the die insert 13A, and the gas supply channel 15 is in fluid connection with a plurality of gas outlet openings 15Aa which are arranged at an outer side of the die insert 13A.

The die insert 13A is configured similar to the die insert 13 of the first embodiment. Due to the configuration of the liquid outlet opening 13Aa of the die insert 13A, the liquid passing through the opening 13Aa is dispersed when entering the mixing portion 14A. The liquid stream dispersed when entering the mixing portion 14A contributes to the formation of fine droplets in the mixing portion 14A, thereby enhancing the foam formation process.

### Second Embodiment—Foam Dispenser Assembly

Similar to the first embodiment, the foam dispenser 10A of the second embodiment can be incorporated in a foam dispenser assembly, as for example a foam dispenser assembly 100 of FIGS. 8-9. The foam dispenser assembly 100 can be attached to a vessel or container used for storing a foamable aqueous composition therein.

### Third Embodiment—Foam Dispenser

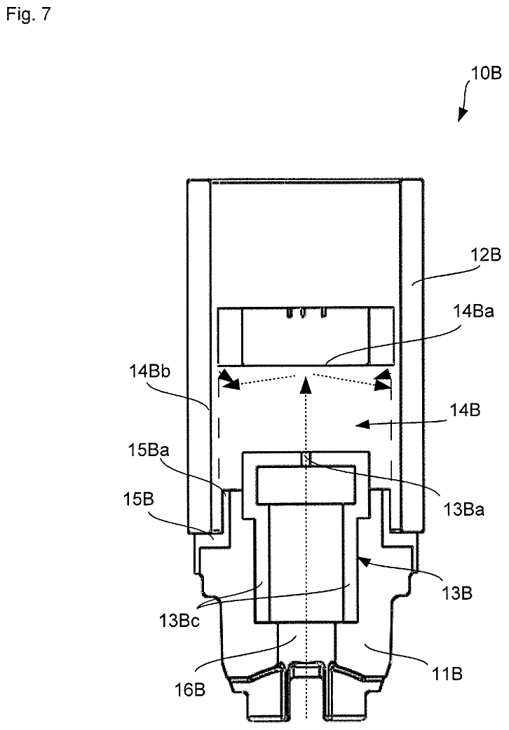

A third embodiment of a foam dispenser 10B is shown in FIG. 7. The foam dispenser 10B differs from the foam dispenser 10 of the first embodiment in that a die insert with a configuration as further specified below is used.

### Third Embodiment—Die Insert

In particular, the die insert 13B of the foam dispenser 10B is configured so that a liquid outlet opening 13Ba provided at a center portion of the die insert 13B has, in cross section, a substantially cylindrical shape.

The foam dispenser 10B comprises a base portion 11B and a front portion 12B connected to each other. An outer circumferential wall 11Ba of a first end portion of the base portion 11B engages an inner circumferential wall of the front portion 12B. On a radially inner side of the outer circumferential wall lla of the base portion 11B, a circumferential gap is provided which forms a liquid supply channel 16B. A protruding portion 13Bc of a die insert 13 is inserted into the gap of the base portion 11B, thereby attaching the die insert 13B to the base portion 11B.

A mixing portion (mixing chamber) 14B is formed between the base portion 11B and the front portion 12B. In particular, the mixing portion 14B is provided between an upper section of the die insert 13B attached to the base portion 11B, an inner circumferential wall 14Bb of the front portion 12B and an inner wall 14Ba of the front portion 12B, the inner wall 14Ba being opposite to the upper section of the die insert 13B. The die insert 13B is attached to the base portion 11B so that the upper section of the die insert 13B provides a bottom portion of the mixing portion 14B.

### Third Embodiment—Inner Wall

The inner wall 14Ba of the mixing portion 14 is provided with a plurality of orifices (not shown in the FIG. 6, but similar to the orifices of the first embodiment).

### Third Embodiment—Liquid and Gas Supply Channels

The foam dispenser 10B further comprises the liquid supply channel 16B formed by the circumferential gap in the base portion 11B and a gas supply channel 15B. The liquid supply channel 16B is arranged closer to the axis of the base portion 11B as compared to the gas supply channel 15B.

The liquid supply channel 16B and the gas supply channel 15B are in fluid connection with the mixing portion 14B. In particular, the liquid supply channel 16B is in fluid connection with the liquid outlet opening 13Ba provided in the die insert 13B. The gas supply channel 15B is in fluid connection with a plurality of gas outlet openings 15Ba which are arranged at an outer side of the die insert 13B.

The inner wall 14Ba is arranged opposite to the liquid outlet opening 13Ba so that liquid entering the mixing portion 14B through the liquid outlet opening 13a is directed to the inner wall 14Ba.

By this arrangement, the inner wall 14Ba serves as a dispersing section which is configured to disperse a liquid stream which has passed through the opening 13Ba and through the mixing portion 14B. Since the liquid stream is formed as a jet stream, the velocity of the liquid stream is relatively high. The liquid stream passes the mixing portion 14B and is then dispersed by the inner wall 14Ba so that fine droplets are provided in the mixing portion 14B. The fine droplets mix with the gas supplied by the plurality of gas outlet openings 15Ba, thereby providing stable foam with soft feel and rich appearance.

### Third Embodiment—Foam Dispenser Assembly

Similar to the first or second embodiment, the foam dispenser 10B of the third embodiment can be incorporated in a foam dispenser assembly, as for example a foam dispenser assembly 100 of FIGS. 8-9. The foam dispenser assembly 100 can be attached to a vessel or container used for storing a foamable aqueous composition therein.

With respect to other components of the third embodiment, which are not specifically described, reference is made to either the first embodiment or the second embodiment, or modifications/variations thereof.

Foam Dispenser Assembly

In another aspect, a foam disperser assembly with the foam dispenser according to any of the preceding aspects and a liquid container are provided. The foam dispenser assembly can be selected from a propellant foamer assembly, a pump foamer assembly and a squeeze foamer assembly, and more preferably is a pump foamer assembly.

The foam dispenser assembly can comprise an aqueous composition for cleansing of skin and/or hair, comprising
one or more foaming surfactant(s),
one or more particles insoluble in water at 25° C. and under atmospheric pressure having a number average particle size in the range of 1 μm to 250 μm determined by static light scattering. With this configuration, the foam produced by the foam dispenser has in addition an enhanced cleaning effect.

According to a further aspect of the invention, a vessel for storing a foamable aqueous composition is provided, which comprises a cap with the foam dispenser according to one or more of the previously mentioned aspects.

Method for Forming Foam

As another embodiment, the invention provides a method for forming foam. According to the method, the foam dispenser according to any one or more of the previous aspects or the foam dispenser assembly according to one or more of the previous embodiments can be used. The method comprises the steps of: introducing gas, in particular pressurized air, in a mixing portion and introducing liquid in the mixing portion. The liquid is introduced so that the liquid stream is dispersed when or after entering the mixing portion to mix with the gas in a dispersed state.

According to this method, foam with a small and uniform bubble size, high foam stability and a rich appearance can be provided.

1. A foam dispenser, comprising:
a base portion and a front portion,
a mixing portion being formed between the base portion and the front portion, the mixing portion having a circumferential wall,
at least one liquid supply channel and at least one gas supply channel, the liquid supply channel and the gas supply channel being in fluid connection with the mixing portion via at least one liquid outlet opening and at least one gas outlet opening, respectively,
wherein
the foam dispenser comprises at least one dispersing section, wherein the dispersing section is configured to disperse a liquid stream when or after entering the mixing portion to mix with the gas in a dispersed state, and
wherein the dispersing section comprises an inner wall, which is arranged opposite to the liquid outlet opening.

2. The foam dispenser according to claim 1, wherein the gas entering the mixing portion is a pressurized gas.

3-18. (canceled)

19. The foam dispenser according to claim 1, wherein the gas entering the mixing portion is pressurized air.

20. The foam dispenser according to claim 1, wherein a die insert, which is attached to the base portion, comprises the liquid outlet opening.

21. The foam dispenser according to claim 1, wherein the dispersing section comprises an inner wall, which is arranged opposite to the liquid outlet opening.

22. The foam dispenser according to claim 1, wherein the inner wall is arranged so that at least parts of the liquid dispensed from the liquid outlet opening reach the inner wall prior to deflection at the circumferential wall of the mixing portion.

23. The foam dispenser according to claim 1, wherein the inner wall comprises one or more orifices for discharging foam and the location of the one or more orifices is/are radially outward of the liquid outlet opening.

24. The foam dispenser according to claim 1, wherein none of the one or more orifices is in axial direction to the liquid outlet opening.

25. The foam dispenser according to claim 1, wherein the liquid outlet opening is configured as a jet die to discharge a jet of liquid in axial direction against the inner wall.

26. The foam dispenser according to claim 1, wherein the dispersing section comprises the liquid outlet opening which is configured as a dispersing die to disperse the liquid stream leaving the opening.

27. The foam dispenser according to claim 26, wherein the liquid outlet opening is connected to the liquid supply channel via one or more liquid flow channels, the liquid flow channels having narrower cross-section than the liquid supply channel.

28. The foam dispenser according to claim 27, wherein the liquid flow channels are connected with the liquid outlet opening in a non-mirror-symmetric manner so as to confer a rotational component to the discharged liquid.

29. The foam dispenser according to claim 1, wherein
the liquid outlet opening and the gas outlet opening are located apart and on different walls of the mixing portion, or
the liquid outlet opening of the liquid supply channel and the gas outlet opening of the gas supply channel are located apart and on different walls of the mixing portion.

30. The foam dispenser according to claim 1, wherein the gas outlet opening is located at a radially outer side of the liquid outlet opening.

31. The foam dispenser according to claim 1, wherein the ratio of the largest cross-sectional distance of one or more gas outlet openings to the diameter of the liquid outlet opening is in the range of 1:0.25 to 1:4.

32. The foam dispenser according to claim 1, wherein the liquid outlet opening is configured as a venturi nozzle.

33. A foam dispenser assembly, comprising the foam dispenser according to claim 1 and a liquid container.

34. The foam dispenser assembly according to claim 33, wherein the foam dispenser assembly is selected from a propellant foamer assembly, a pump foamer assembly, and a squeeze foamer assembly.

35. A vessel for storing a foamable aqueous composition having attached to it a cap comprising the foam dispenser according to claim 1.

36. A method for forming foam using the foam dispenser according to claim 1, the method comprising:
introducing a gas, in particular pressurized air, in a mixing portion, and
introducing a liquid in the mixing portion,
wherein the liquid is introduced so that the liquid stream is dispersed when or after entering the mixing portion to mix with the gas in a dispersed state.
